(19) United States
(12) Patent Application Publication
(10) Pub. No.: US 2025/0077957 A1
(43) Pub. Date: Mar. 6, 2025

(54) QUALITY ASSURANCE FOR MACHINE LEARNING USING DISTRIBUTION PATTERNS RELATED TO TRAINING DATASETS

(71) Applicant: Optum., Inc., Minnetonka, MN (US)

(72) Inventors: Sudhanshu Sharma, Bangalore (IN); Ayan Sengupta, Noida (IN)

(21) Appl. No.: 18/460,093

(22) Filed: Sep. 1, 2023

(51) Int. Cl. G06N 20/00

(52) U.S. Cl. CPC G06N 20/00

(57) ABSTRACT

Various embodiments of the present disclosure provide quality assurance for machine learning using distribution patterns related to training datasets. In one example, an embodiment provides for generating an augmented training dataset of a plurality of augmented training datasets for a machine learning model by randomly modifying a subset of binary labels of a training dataset for the machine learning model based on a probability value, generating a graphical distribution pattern for the training dataset based on a plurality of accuracy scores of the plurality of augmented training datasets, and generating a quality score for the training dataset based on a comparison between the graphical distribution pattern and a predefined graphical distribution pattern.

### BACKGROUND

Various embodiments of the present disclosure address technical challenges related to performing machine learning data analysis in a computationally accurate, efficient, and/or consistent manner. Existing machine learning data analysis systems are ill-suited to accurately, efficiently, and/or consistently perform predictive data analysis in various domains, such as domains that are associated with high-dimensional categorical feature spaces with a high degree of cardinality.

### BRIEF SUMMARY

In general, various embodiments of the present disclosure provide methods, apparatus, systems, computing devices, computing entities, and/or the like for providing quality assurance for machine learning using distribution patterns related to training datasets. Some embodiments of the present disclosure improve upon traditional machine learning systems by enabling accurate, efficient, and/or consistent training datasets for a machine learning model. The resulting trained machine learning model may result in reduced computing resources, more accurate predictions, improved learning, and/or improved quality assurance as compared to traditional machine learning systems.

In some embodiments, a computer-implemented method includes generating, by one or more processors, an augmented training dataset of a plurality of augmented training datasets for a machine learning model by randomly modifying a subset of binary labels of a training dataset for the machine learning model based on a probability value. In some embodiments, the computer-implemented method additionally or alternatively includes generating, by the one or more processors, a graphical distribution pattern for the training dataset based on a plurality of accuracy scores of the plurality of augmented training datasets. In some embodiments, the computer-implemented method additionally or alternatively includes generating, by the one or more processors, a quality score for the training dataset based on a comparison between the graphical distribution pattern and a predefined graphical distribution pattern. In some embodiments, the computer-implemented method additionally or alternatively includes initiating, by the one or more processors, a machine learning action using the machine learning model based on the quality score for the training dataset.

In some embodiments, a computing system includes memory and one or more processors communicatively coupled to the memory. In some embodiments, the one or more processors are configured to generate an augmented training dataset of a plurality of augmented training datasets for a machine learning model by randomly modifying a subset of binary labels of a training dataset for the machine learning model based on a probability value. In some embodiments, the one or more processors are additionally or alternatively configured to generate a graphical distribution pattern for the training dataset based on a plurality of accuracy scores of the plurality of augmented training datasets. In some embodiments, the one or more processors are additionally or alternatively configured to generate a quality score for the training dataset based on a comparison between the graphical distribution pattern and a predefined graphical distribution pattern. In some embodiments, the one or more processors are additionally or alternatively configured to initiate a machine learning action using the machine learning model based on the quality score for the training dataset.

In some embodiments, one or more non-transitory computer-readable storage media include instructions that, when executed by one or more processors, cause the one or more processors to generate an augmented training dataset of a plurality of augmented training datasets for a machine learning model by randomly modifying a subset of binary labels of a training dataset for the machine learning model based on a probability value. In some embodiments, the instructions, when executed by the one or more processors, additionally or alternatively cause the one or more processors to generate a graphical distribution pattern for the training dataset based on a plurality of accuracy scores of the plurality of augmented training datasets. In some embodiments, the instructions, when executed by the one or more processors, additionally or alternatively cause the one or more processors to generate a quality score for the training dataset based on a comparison between the graphical distribution pattern and a predefined graphical distribution pattern. In some embodiments, the instructions, when executed by the one or more processors, additionally or alternatively cause the one or more processors to initiate a machine learning action using the machine learning model based on the quality score for the training dataset.

### BRIEF DESCRIPTION OF THE DRAWINGS

FIG. 1 provides an example overview of an architecture in accordance with one or more embodiments of the present disclosure.

FIG. 2 provides an example machine learning computing entity in accordance with one or more embodiments of the present disclosure.

FIG. 3 provides an example external computing entity in accordance with one or more embodiments of the present disclosure.

FIG. 4 provides an example computing system that provides quality assurance for machine learning using distribution patterns related to training datasets in accordance with one or more embodiments of the present disclosure.

FIG. 5 provides example graphical distribution patterns in accordance with one or more embodiments of the present disclosure.

FIG. 6 provides example data associated with high-quality data annotation in accordance with one or more embodiments of the present disclosure.

FIG. 7 provides an example computing system that provides for machine learning actions and/or visualizations in accordance with one or more embodiments of the present disclosure.

FIG. 8 provides an example user interface related to visualizations in accordance with one or more embodiments of the present disclosure.

FIG. 9 is a flowchart diagram of an example process for generating a prediction output for data using machine learning and quality assurance in accordance with one or more embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

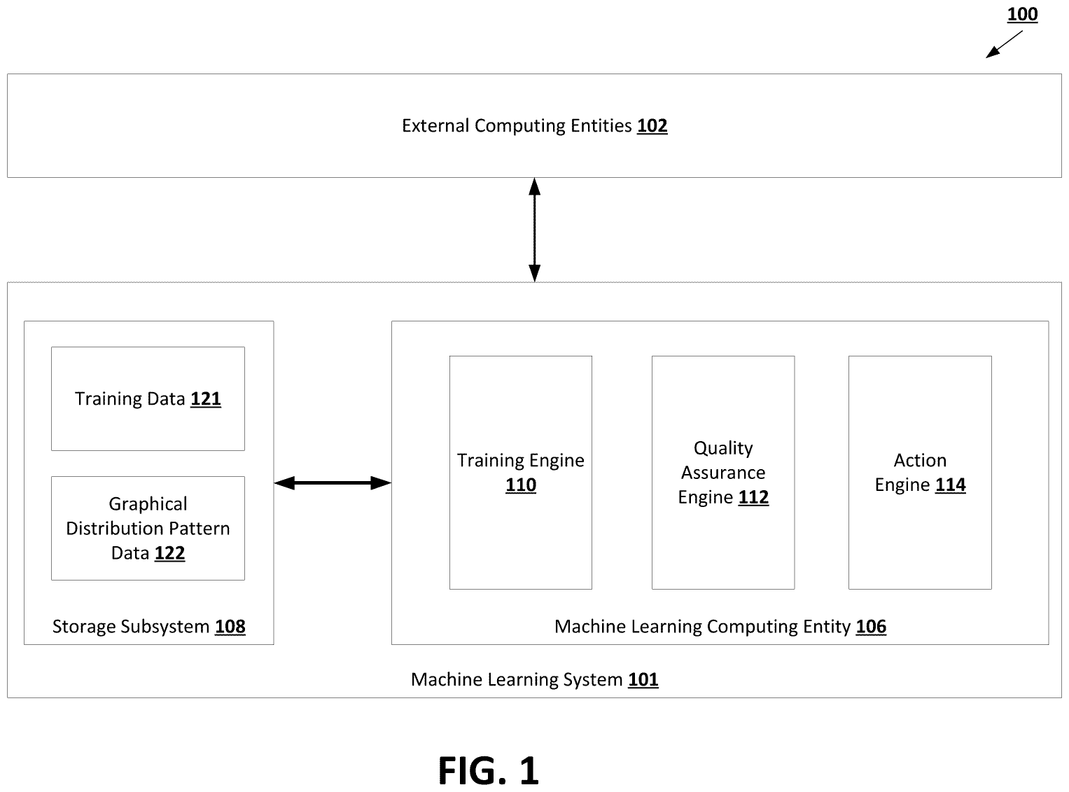

FIG. 1 provides an example overview of an architecture 100 that may be used to practice embodiments of the present disclosure. The architecture 100 includes a machine learning system 101 and one or more external computing entities 102. For example, at least some of the one or more external computing entities 102 may provide inputs to the machine learning system 101. Additionally, or alternatively, at least some of the one or more external computing entities 102 may receive decision outputs, task outputs, machine learning outputs, prediction outputs, classification outputs, and/or action outputs from the machine learning system 101 in response to providing the inputs. As another example, at least some of the external computing entities 102 may provide one or more data streams and/or one or more batch loads to the machine learning system 101 and request performance of particular prediction-based actions in accordance with the provided one or more data streams and/or one or more batch loads. As a further example, at least some of the external computing entities 102 may provide training data (e.g., one or more training datasets) to the machine learning system 101 and request training of one or more machine learning models in accordance with the provided training data. In some of the noted embodiments, the machine learning system 101 may be configured to transmit parameters, hyper-parameters, and/or weights of a trained machine learning model to the external computing entities 102.

In some embodiments, the machine learning system 101 may include a machine learning computing entity 106. The machine learning computing entity 106 and the external computing entities 102 may be configured to communicate over a communication network (not shown). The communication network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The machine learning computing entity 106 may be configured to provide one or more predictions using one or more artificial intelligence techniques and/or one or more machine learning techniques. For instance, the machine learning computing entity 106 may be configured to determine forecasts, insights, predictions, and/or classifications related to data from disparate database systems. The machine learning computing entity 106 may be additionally, or alternatively configured to compute optimal decisions, display optimal data for a dashboard (e.g., a graphical user interface), generate optimal data for reports, optimize actions, and/or optimize configurations associated with a decision management system, a workflow management system, a clinical decision automation system, a medical claim adjudication system, a clinical review system, and/or another type of system.

The machine learning computing entity 106 includes a training engine 110, a quality assurance engine 112, and/or an action engine 114. The training engine 110 performs data labeling and/or feature extractions associated with data (e.g., categorical data, text data, and/or numerical data) to determine one or more training datasets for one or more machine learning models. In some embodiments, a training dataset may include binary labels associated with the data. The training engine 110 additionally, or alternatively performs training with respect to one or more machine learning models based on the training dataset. For example, the training engine 110 may perform a training process associated with one or more training stages to provide a trained machine learning model that satisfies quality and/or accuracy criterion for one or more machine learning tasks such as forecasts, insights, predictions, and/or classifications related to data. The quality assurance engine 112 performs quality assurance for one or more machine learning models. In some embodiments, the quality assurance engine 112 may generate one or more augmented training datasets for a machine learning model by randomly modifying a subset of the binary labels of a training dataset for the machine learning model based on one or more probability values. In some embodiments, the quality assurance engine 112 may additionally, or alternatively generate a graphical distribution pattern for a training dataset based on accuracy scores of augmented training datasets. In some embodiments, the quality assurance engine 112 may additionally, or alternatively generate a quality score for a training dataset based on a comparison between a graphical distribution pattern and a predefined graphical distribution pattern.

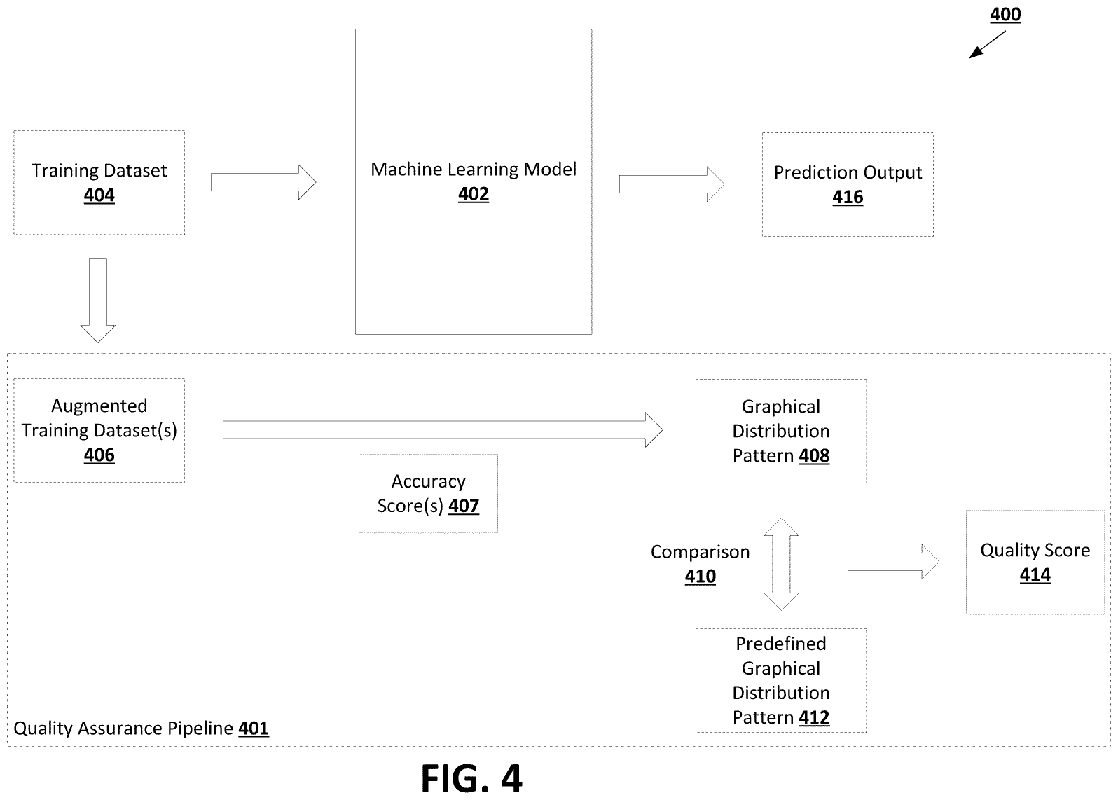

The action engine 114 performs one or more actions (e.g., one or more machine learning actions) using a machine learning model. In some embodiments, the action engine 114 may additionally, or alternatively utilize one or more predictions and/or classifications associated with a machine learning model to perform one or more actions. In some embodiments, the action engine 114 may utilize one or more predictions and/or classifications to provide one or more visualizations via user interface of a display (e.g., display 316). In certain embodiments, the action engine 114 may utilize one or more predictions and/or classifications associated with the quality assurance engine 112 to optimize and/or retrain one or more machine learning models. As such, the machine learning computing entity 106 may provide accurate, efficient and/or reliable predictions and/or classifications using machine learning. Further example operations of the quality assurance engine 112, and/or the action engine 114 are described with reference to at least FIGS. 4-9.

Additionally, in some embodiments, the machine learning system 101 includes a storage subsystem 108. In some embodiments, the storage subsystem 108 stores training data 121 and/or graphical distribution pattern data 122. The training data 121 may include one or more training datasets associated with one or more machine learning models. For example, the training data 121 may include one or more training datasets utilized by the training engine 110. The graphical distribution pattern data 122 may include one or more graphical distribution patterns for one or more training datasets. Additionally, or alternatively, the graphical distribution pattern data 122 may include one or more predefined graphical distribution patterns. The storage subsystem 108 may include one or more storage units, such as multiple distributed storage units that are connected through a computer network. In certain embodiments, the training data 121 and/or the graphical distribution pattern data 122 may be stored in disparate storage units (e.g., disparate databases) of the storage subsystem 108. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

Various embodiments provide technical solutions to technical problems corresponding to machine learning training and/or machine learning data analysis. For example, supervised learning classification is a common technique utilized for machine learning technologies. For prediction tasks related to supervised learning classification, machine learning models may be trained on annotated training data. With the annotated training data, it is imperative to determine whether the annotator has performed his/her job reasonably well in order to provide quality training data for the machine learning models. However, creating ground truth labels for training data is expensive, laborious, and/or time-consuming. For example, the process of labeling training data typically involves contextual understanding, applying prior domain knowledge, and/or utilization of heuristics to determine ground truth labels. As such, the subjectivity associated with data label annotation often leads to human judgement bias which impacts the quality of labels for training data. Moreover, machine learning techniques related to sparse data and/or data stored in disparate data sources may be difficult, resource intensive, and/or inaccurate. For example, training of a machine learning model based on sparse data may result in inaccurate predictions. Additionally, extensive querying of databases as a result of sparse data for training a machine learning model generally involves inefficient usage of computational resources. However, with the architecture 100 and one or more other embodiments disclosed herein, one or more technical improvements may be provided such as improved accuracy and a reduction in computationally intensiveness and time intensiveness needed for training and/or optimizing machine learning models. With the architecture 100 and one or more other embodiments disclosed herein, improved accuracy and a reduction in computational resources required for performing machine learning data analysis using one or more machine learning models may also be provided. The architecture 100 may also allocate processing resources, memory resources, and/or other computational resources to other tasks while executing one or more processes related to providing machine learning data analysis in parallel. As such, various embodiments of the present disclosure therefore provide improvements to the technical field of machine learning. In certain embodiments, a graphical user interface of a computing device that renders at least a portion of predictions, classifications, and/or insights may also be improved by optimally presenting visual data related to the predictions, classifications, and/or insights.

### III. Examples of Certain Terms

In some embodiments, the term “classification model” refers to a data construct that describes parameters, hyperparameters, coefficients, and/or defined operations to provide one or more classifications related for an input dataset. The one or more classifications provided by the classification model may be binary labels or another type of classification. In various embodiments, the classification model utilizes one or more machine learning techniques using parameters, hyperparameters, and/or defined operations. A classification model may include one or more of any type of machine learning model including one or more supervised, unsupervised, semi-supervised, reinforcement learning models, and/or the like. For instance, a classification model may include a supervised model that may be trained using a training dataset. In some examples, a classification model may include multiple models configured to perform one or more different stages of a classification and/or prediction process.

In some embodiments, the classification model is a machine learning model, such as a neural network, a deep learning model, a logistic regression model, a decision tree, a random forest, support vector machine (SVM), a Naïve Bayes classifier, and/or any other type of machine learning model. For instance, the classification model may include one or more rule-based layers, one or more layers that depend on trained parameters, hyperparameters, coefficients, defined operations, and/or the like. In some examples, the classification model is trained (e.g., by updating the one or more parameters, and/or the like) using one or more supervised training techniques. In some examples, a configuration, type, and/or other characteristics of the classification model may be dependent on the particular domain. In various embodiments, the classification model is trained, using a training dataset, to generate a classification (and/or probability thereof) for a particular domain.

In some embodiments, the term “training dataset” refers to input data provided to the classification model during one or more training stages for the classification model to train and/or configure the classification model to perform a classification task based on the particular domain for the classification model. The type, format, and/or parameters of the training dataset may be based on the particular domain for the classification model. In various embodiments, the training dataset includes ground-truth labels, such as binary labels, ground-truth classifications, ground-truth text classifications, ground-truth numerical classifications, ground-truth categorical classifications, and/or the like). In various embodiments, the training dataset includes respective binary targets obtained via binary logistic regression.

In some embodiments, the term “binary label” refers to a data construct that classifies data as either a first binary label (e.g., a first class label) or a second binary label (e.g., a second class label) for a particular domain. For example, a binary label may classify data as either “high” risk or “low” risk. In another example, a binary label may classify data as either “yes” or “no”.

In some embodiments, the term “probability value” refers to a data construct corresponding to a value between 0 and 1. For example, a probability value may correspond to a percentage of binary labels in training dataset to modify. In a non-limiting example, a probability value equal to 0.6 may refer to 60% of binary labels in a training dataset.

In some embodiments, the term “graphical distribution pattern” refers to a data construct or data structure that maps a plurality of accuracy scores for a plurality of training datasets against respective probability values for the plurality of training datasets. In various embodiments, the graphical distribution pattern is a plot with y-coordinate values corresponding to respective accuracy scores for a plurality of training datasets and x-coordinate values corresponding to respective probability values. In various embodiments, the graphical distribution pattern is a performance-probability distribution representative of an annotation quality assurance profile for binary labeling related to training datasets.

In some embodiments, the term “predefined graphical distribution pattern” refers to a predefined data construct or predefined data structure that represents a predefined pattern corresponding to an optimal annotation quality assurance profile for binary labeling. In various embodiments, the predefined graphical distribution pattern is a predefined parabola pattern corresponding to an optimal annotation quality assurance profile for binary labeling related to a particular domain for a classification model.

In some embodiments, the term “accuracy score” refers to a data construct corresponding to predicted or measured accuracy for a training dataset and/or binary labels. In various embodiments, the accuracy score represents a performance evaluation result for a training dataset and/or binary labels. In various embodiments, the accuracy score is an F-score such as an F1 score. For example, the accuracy score may be determined using micro-averaging or macro-averaging of classification frequency in a training dataset and/or a set of binary labels.

In some embodiments, the term “quality score” refers to a data construct corresponding predicted or measured quality for a training dataset and/or binary labels. In various embodiments, the quality score may be based on a distance measure such as, for example, a Hausdorff distance. For example, the quality score may correspond to 1-Hausdorff distance where a higher quality score corresponds to closer correlation between first data and second data. In various embodiments, the quality score may be determined based on a comparison between a graphical distribution pattern and a predefined graphical distribution pattern. The quality score may be indicative of an accuracy of a labeled training dataset. For example, the quality score may indicate whether a training dataset is associated with high-quality data annotation or low-quality data annotation.

In some embodiments, the term “quality criterion” refers to a threshold value, metrics, rules, standards, predefined behavior, and/or other quality criterion utilized to determine a degree of quality for a quality score. For example, the quality criterion may include a particular threshold value, such as 0.8, that is indicative of high quality for a quality score.

In some embodiments, the term “categorical data” refers to an electronically maintained data construct that is configured to describe data pertaining to one or more data sources and/or one or more events. In some embodiments, the categorical data may refer to one or more portions of one or more medical records and/or medical data. In some embodiments, the categorical data may include a plurality of predictive codes, a plurality of character patterns for a plurality of character pattern positions, and/or data associated therewith.

In some embodiments, the term “prediction output” refers to a data construct that describes one or more prediction insights, classifications, and/or inferences provided by one or more machine learning models. In various embodiments, prediction insights, classifications, and/or inferences may be with respect to one or more data objects and/or features of one or more groupings of text, such as, one or more portions of a document. In certain embodiments, a prediction output may provide a prediction as to whether medical records for a patient indicates that a patient is associated with a particular type of disease, such as, a particular type of rare disease.

In some embodiments, the term “machine learning framework” refers to a data construct that describes parameters, hyperparameters, and/or defined operations of one or more machine learning models configured to generate a prediction output for a prediction input data object. In some embodiments, the machine learning framework process one or more input segments, one or more document segments, one or more predictive codes, categorical data, and/or other data related to one or more input document data objects. A machine learning framework may be configured to provide a prediction for one or more input segments, one or more document segments, one or more predictive codes, categorical data, and/or other data related to one or more input document data objects via respective attributes and/or features for one or more map representations applied to the one or more machine learning techniques.

### IV. Overview, Technical Improvements, and Technical Advantages

The present disclosure addresses technical challenges related to performing machine learning data analysis in a computationally efficient and predictively reliable manner. Existing machine learning data analysis systems are generally ill-suited to accurately, efficiently, and/or reliably perform predictive data analysis in various domains, such as domains that are associated with high-dimensional categorical feature spaces with a high degree of cardinality. Additionally, creating ground truth labels for training data for machine learning data analysis is expensive, laborious, and/or time-consuming. For example, the process of labeling training data typically involves contextual understanding, applying prior domain knowledge, and/or utilization of heuristics to determine ground truth labels. Moreover, existing frameworks for labeling training data do not objectively perform quality assessment of labels and/or other training data for classification tasks. As such, the subjectivity associated with data label annotation often leads to human judgement bias which impacts the quality of labels for training data. Additionally, configuring machine learning techniques using sparse data and/or data stored in disparate data sources may be difficult, resource intensive, and/or inefficient. For example, training of a machine learning models based on sparse data may result in reduced accuracy and inaccurate predictions.

Discussed herein are methods, apparatus, systems, computing devices, computing entities, and/or the like for analysis of digital data using machine learning. In various embodiments, methods, apparatus, systems, computing devices, computing entities, and/or the like provide quality assurance for annotated data (e.g., labeled data) utilized to train one or more machine learning models.

Certain embodiments utilize methods, apparatus, systems, computing devices, computing entities, and/or the like for additionally performing actions based on the analysis of the digital data and/or predictions associated therewith. In various embodiments, machine learning models may provide classification predictions, such as, diagnostic predictions or other predictions related to categorical data. As will be recognized, some of the embodiments of the present disclosure may be used to perform any type of artificial intelligence for predictions related to categorical data. Examples of artificial intelligence include, but are not limited to, machine learning, supervised machine learning (e.g., classification analysis, regression analysis, etc.), classifiers, logistic regression modeling, linear regression modeling, unsupervised machine learning (e.g., clustering analysis, etc.), deep learning, neural network architectures, and/or the like.

In some prediction domains machine learning models may be trained on sparse or external data due to a lack of accessibility to robust training datasets. By way of example, in clinical prediction domains, health care organizations may rely on information from disparate database systems to facilitate providing one or more products and/or one or more services. By relying on such data, models developed for these prediction domains require additional processing and memory resources. Even if available, the data accessed for training the models may be inefficient in breadth to accurately, efficiently, and/or reliably provide insights and forecasts related a particular prediction domain.

In prediction domains that are limited to sparse or external datasets, such as the clinical prediction domain in the above example, validating the consistency of target labels in a dataset has an increased significance to the viability of a predictive analysis process as errors in labels obtained via human annotation may adversely impact performance of a trained model on unseen data. This may be especially influential for certain types of predictive analysis tasks, such as predicting rare events (e.g., rare diseases using clinical data, etc.), predicting the risk (e.g., low risk vs. high risk) of a rare event, and/or the like. In some examples, the target variable in such use cases may be a binary label and the successful outcome of the predictive analysis may depend on how well these binary labels have been annotated.

Traditionally, binary labels are manually created, which may result in errors when labeling such data. The prevalency of such error may be intensified in prediction domains in which a binary classification is contingent on multiple factors without aclear-cut demarcation of a particular classification over another classification. By way of example, in a clinical domain for classifying a patient's risk of disease, an annotation consistency issue may arise when a first and second patient with similar conditions should have similar risk factors, but the predicted risk for the first and second patients are inconsistent (e.g., the first patient is correlated to a high-risk label via a machine learning model and the second patient is correlated to a low-risk label via the machine learning model). Inconsistent labels, such as these, are difficult to detect in data for accurate quality assurance of data labeling and result in significant performance degradation for machine learning models.

Various embodiments of the present disclosure address technical challenges related to providing insights and/or forecasts related to data for accurately, efficiently, and reliably performing predictive data analysis in prediction domains. In various embodiments, quality assurance for machine learning is provided using statistical techniques related to training datasets. In various embodiments, quality assurance for machine learning is provided using distribution patterns related to training datasets. In various embodiments, a quality assurance techniques may be provided to assist with managing and/or identifying inconsistencies across data labels in order to improve learning capabilities for machine learning processes and/or machine learning models.

The quality assurance techniques may include an automated quality checker for annotated data labels. For example, the quality assurance techniques may utilize an automated quality checker process for annotated data labels related to binary classifications. In various embodiments, a machine learning model such as a classification model or another type of machine learning model may be trained using an input dataset related to binary targets. The input dataset may include text data, numerical data, and/or categorical data. In various embodiments, the quality assurance techniques may be performed for machine learning model to reliably train the machine learning model.

For example, the quality assurance techniques may include creating a plurality of new datasets by randomly modifying a subset of binary labels for a portion of binary labels based on a respective probability value, calculating a performance evaluation score for each of the newly created datasets, generating a performance-probability distribution that plots the performance evaluation scores against the corresponding probability values, calculating a distance measurement (e.g., a Hausdorff distance) between the performance-probability distribution and a reference distribution pattern, and/or determining quality of the binary labels based on the distance measurement. In various embodiments, the reference distribution pattern may correspond to a parabola shape representative of an annotation quality assurance profile for a binary labeled training dataset.

In various embodiments, the trained machine learning model may be utilized for one or more machine learning tasks in response to a determination that the quality of the binary labels satisfies quality criterion. For example, the trained machine learning model may be utilized to provide classification predictions such as diagnostic predictions. In certain embodiments, the trained machine learning model may be utilized to identify diseases and/or risk profiles associated therewith. In certain embodiments, a front-end visualization may also be provided for end-users to engage with a prediction task or another type of insight related to forecasted outputs, insights, predictions, and/or classifications.

The quality assurance techniques of the present disclosure may provide a machine learning model that is more efficient to train and/or more reliable after a trained version of the machine learning model is generated. In doing so, various embodiments of the present disclosure address shortcomings of existing machine learning data analysis solutions and enable solutions that are capable of efficiently and reliably performing machine learning data analysis in prediction domains with sparse input spaces as well as conveying temporal information.

The quality assurance techniques of the present disclosure may also provide significant advantages over existing technological solutions such as improved integrability, reduced complexity, improved accuracy, and/or improved speed as compared to existing technological solutions for providing insights and/or forecasts related to data. Accordingly, by employing various techniques related to the quality assurance for machine learning disclosed herein, various embodiments of the present disclosure enable utilizing efficient and reliable machine learning solutions to process data feature spaces with a high degree of size, diversity, and/or cardinality. In doing so, various embodiments of the present disclosure address shortcomings of existing system solutions and enable solutions that are capable of accurately, efficiently, and/or reliably providing forecasts, insights, and classifications to facilitate optimal decisions and/or actions for particular prediction domains, such as those related to the health information with sparse datasets.

Moreover, by employing various techniques related to the quality assurance for machine learning disclosed herein, one or more other technical benefits may be provided, including improved interoperability, improved reasoning, reduced errors, improved information/data mining, improved analytics, and/or the like related to machine learning. Accordingly, the quality assurance techniques of the present disclosure provide improved predictive accuracy, while improving training speeds given a constant predictive accuracy. In doing so, the techniques described herein may additionally, orimprove efficiency and speed of training machine learning models, thus reducing the number of computational operations needed and/or the amount of training data entries needed to effectively train machine learning models. Accordingly, the techniques described herein improve the computational efficiency, storage-wise efficiency, and speed of training machine learning models.

### V. Example System Operations

As described herein, some embodiments of the present disclosure provide improved quality assurance techniques to enable efficient and reliable machine learning solutions to process data feature spaces with a high degree of size, diversity, and/or cardinality. In doing so, various embodiments of the present disclosure enable machine learning solutions that are capable of accurately, efficiently, and reliably providing forecasts, insights, and classifications to facilitate optimal decisions and/or actions in prediction domains with sparse datasets, such as clinical domains with rare diseases. Moreover, by employing various techniques related to the machine learning framework disclosed herein, one or more other technical benefits may be provided, including improved interoperability, improved reasoning, reduced errors, improved information/data mining, improved analytics, and/or the like related to machine learning. Accordingly, the improved quality assurance techniques of the present disclosure and the machine learning frameworks thereof may provide improved predictive accuracy without reducing training speed and also enable improving training speed given a constant predictive accuracy. In doing so, the techniques described herein may additionally, or alternatively improve efficiency and speed of training machine learning models, thus reducing the number of computational operations needed and/or the amount of training data entries needed to train machine learning models. Accordingly, the techniques described herein improve the computational efficiency, storage-wise efficiency, and speed of training machine learning models.

### Example Classification Prediction Machine Learning Computing Entity

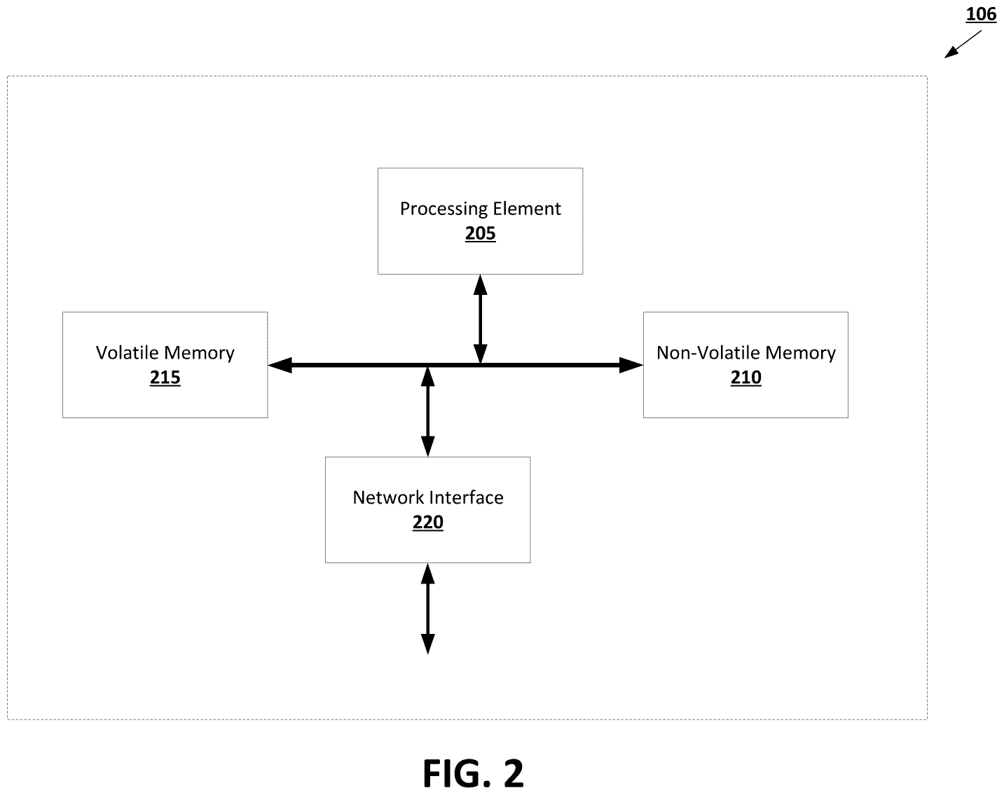

FIG. 2 provides a schematic of the machine learning computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the machine learning computing entity 106 may also include a network interface 220 for communicating with various computing entities, such as by communicating data, content, information, and/or similar terms used herein interchangeably that may be transmitted, received, operated on, processed, displayed, stored, and/or the like. Furthermore, it is to be appreciated that the network interface 220 may include one or more network interfaces.

As shown in FIG. 2, in one embodiment, the machine learning computing entity 106 may include or be in communication with processing element 205 (also referred to as processors, processing circuitry, and/or similar terms used herein interchangeably) that communicate with other elements within the machine learning computing entity 106 via a bus, for example. It is to be appreciated that the processing element 205 may include one or more processing elements. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the machine learning computing entity 106 may further include or be in communication with non-volatile memory 210. The non-volatile memory 210 may be non-volatile media (also referred to as non-volatile storage, memory, memory storage, memory circuitry, and/or similar terms used herein interchangeably). Furthermore, in an embodiment, non-volatile memory 210 may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the machine learning computing entity 106 may further include or be in communication with volatile memory 215. The volatile memory 215 may be volatile media (also referred to as volatile storage, memory, memory storage, memory circuitry, and/or similar terms used herein interchangeably). Furthermore, in an embodiment, the volatile memory 215 may include one or more volatile storage or memory media, including but not limited to RAM, DRAM, SRAM, FPM DRAM, EDO DRAM, SDRAM, DDR SDRAM, DDR2 SDRAM, DDR3SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the machine learning computing entity 106 with the assistance of the processing element 205 and operating system.

As indicated, in one embodiment, the machine learning computing entity 106 may also include the network interface 220. In an embodiment, the network interface 220 may be one or more communications interfaces for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the machine learning computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the machine learning computing entity 106 may include or be in communication with one or more input elements, such as a keyboard input, a mouse input, a touch screen/display input, motion input, movement input, audio input, pointing device input, joystick input, keypad input, and/or the like. The machine learning computing entity 106 may also include, or be in communication with, one or more output elements (not shown), such as audio output, video output, screen/display output, motion output, movement output, and/or the like.

### Example External Computing Entity

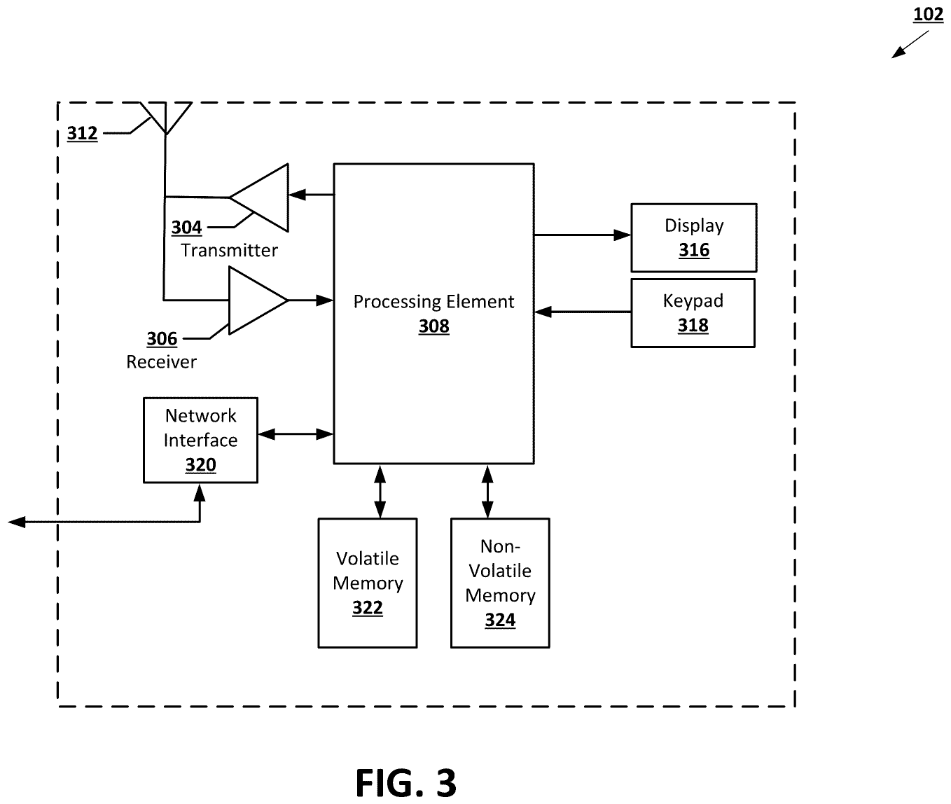

FIG. 3 provides an illustrative schematic representative of an external computing entity 102 that may be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The external computing entity 102 may be operated by various parties. As shown in FIG. 3, the external computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) which provide signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the machine learning computing entity 106. In a particular embodiment, the external computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the machine learning computing entity 106 via a network interface 320.

Via these communication standards and protocols, the external computing entity 102 may communicate with various other entities using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 may also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The external computing entity 102 may also comprise a user interface (that may include a display 316 coupled to the processing element 308) and/or a user input interface (coupled to the processing element 308). For example, the user interface may be a user application, browser, user interface, graphical user interface, dashboard, and/or similar words used herein interchangeably executing on and/or accessible via the external computing entity 102 to interact with and/or cause display of information/data from the machine learning computing entity 106, as described herein. The user input interface may comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *) and other keys used for operating the external computing entity 102, and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The external computing entity 102 may also include volatile memory 322 and/or non-volatile memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile memory 322 and/or the non-volatile memory 324 may store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the machine learning computing entity 106 and/or various other computing entities.

In another embodiment, the external computing entity 102 may include one or more components or functionalities that are the same or similar to those of the machine learning computing entity 106, as described in greater detail above. As will be recognized, these architectures and descriptions are provided for example purposes only and are not limiting to the various embodiments.

In various embodiments, the external computing entity 102 may be embodied as an artificial intelligence (AI) computing entity, such as a virtual assistant AI device, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

As described below, various embodiments of the present disclosure introduce techniques that improve the training accuracy and/or speed of processing machine learning frameworks by introducing a machine learning framework architecture that provides quality assurance for machine learning using distribution patterns related to training datasets. The combination of the noted components enables the proposed machine learning framework to generate more accurate predictions, which in turn increases the training speed of the proposed machine learning framework given a desired predictive accuracy. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures. Accordingly, techniques that improve predictive accuracy without harming training speed, such as various techniques described herein, enable improving training speed given a constant predictive accuracy. Therefore, by improving accuracy of performing machine learning predictions using quality assurance related to distribution patterns for training datasets, various embodiments of the present disclosure improve the training speed of machine learning frameworks given a target predictive accuracy.

In general, embodiments of the present disclosure provide methods, apparatus, systems, computing devices, computing entities, and/or the like for providing quality assurance for machine learning using distribution patterns related to training datasets. Certain embodiments of the systems, methods, and computer program products that facilitate recommendation prediction and/or prediction-based actions employ one or more trained machine learning models and/or one or more machine learning techniques.

Various embodiments of the present disclosure address technical challenges related to accurately, efficiently, and/or reliably performing machine learning data analysis of data stored in disparate data sources. For example, in various embodiments, proposed solutions provide for training machine learning models with respect to training datasets that include text data, numerical data, and/or categorical data. In various embodiments, proposed solutions disclose classification predictions using machine learning. In some embodiments, one or more machine learning models to facilitate classification predictions may be trained and/or generated based on the training data 121 and/or the graphical distribution pattern data 122. After the one or more machine learning models are generated, the one or more machine learning models may be utilized to perform accurate, efficient, and reliable classification predictions.

Quality Assurance for Machine Learning using Distribution Patterns related to Training Datasets

FIG. 4 provides an example computing system 400 related to one or more machine learning models associated with the machine learning computing entity 106 (e.g., the training engine 110, the quality assurance engine 112, and/or the action engine 114), in accordance with one or more embodiments of the present disclosure. The computing system 400 includes a machine learning model 402. The machine learning model 402 may be a classification model or another type of model configured to execute one or more machine learning techniques related to classification tasks. The machine learning model 402 may be trained using a training dataset 404. For example, the machine learning computing entity 106 (e.g., the training engine 110) may perform one or more training stages based on the training dataset 404 to train the machine learning model 402. The training dataset may include a set of binary labels associated with text data, numerical data, categorical data, and/or other data. In certain embodiments, at least a portion of the set of binary labels may be associated with data related to disparate data sources. In various embodiments, at least a portion of the training data 121 may correspond to the training dataset 404.

In various embodiments, the machine learning computing entity 106 (e.g., the quality assurance engine 112) generates one or more augmented training datasets 406 for the machine learning model 402 by randomly augmenting (e.g., modifying) a subset of binary labels of the training dataset 404 model based on a probability value. The probability value may be a data construct corresponding to a value between 0 and 1. For example, a probability value equal to 0.6 may result in 60% of the binary labels in the training dataset 404 being randomly modified to a different binary label value. As such, based on the probability value, the one or more augmented training datasets 406 may respectively be a modified version of the training dataset 404 where one or more binary labels are modified from a first binary label value to a second binary label value.

In various embodiments, based on the one or more augmented training datasets 406, the machine learning computing entity 106 (e.g., the quality assurance engine 112) generates a graphical distribution pattern 408 for the training dataset 404. The graphical distribution pattern 408 may be generated based on one or more accuracy scores 407 of the one or more augmented training datasets 406. For example, the one or more accuracy scores 407 may respectively correspond to an F-score (e.g., an F1 score) that represents a performance evaluation result for a respective augmented training dataset by randomly modifying binary label values based on a particular probability value. In various embodiments, the one or more accuracy scores 407 may represent a combination (e.g., a harmonic mean) of precision scores and recall scores to provide a machine learning metric for classification accuracy via the machine learning model 402 using the respective augmented training dataset.

The graphical distribution pattern 408 may map respective accuracy scores for the one or more augmented training datasets 406 against respective probability values for the one or more augmented training datasets 406. For example, the graphical distribution pattern 408 may plot the respective probability values for the one or more augmented training datasets 406 against the accuracy score for the one or more augmented training datasets 406. Additionally, in various embodiments, the machine learning computing entity 106 (e.g., the quality assurance engine 112) performs a comparison 410 between the graphical distribution pattern 408 and the predefined graphical distribution pattern 412. The predefined graphical distribution pattern 412 may correspond to a predefined parabola pattern representative of an annotation quality assurance profile for a binary labeled training dataset that adequately provides accurate classifications. In various embodiments, the comparison 410 utilizes a distance measurement between the graphical distribution pattern 408 and the predefined graphical distribution pattern 412. For example, the comparison 410 may determine a Hausdorff distance between the graphical distribution pattern 408 and the predefined graphical distribution pattern 412.

In various embodiments, based on the comparison 410, the machine learning computing entity 106 (e.g., the quality assurance engine 112) generates a quality score 414 for the training dataset 404. The quality score 414 may correspond to a predicted or measured quality for the training dataset 404 based on the comparison 410. For example, the quality score 414 may be configured based the distance between the graphical distribution pattern 408 and the predefined graphical distribution pattern 412. In certain embodiments, the quality score 414 may correspond to 1-Hausdorff distance where a higher quality score corresponds to closer correlation between the graphical distribution pattern 408 and the predefined graphical distribution pattern 412. In various embodiments, the one or more augmented training datasets 406, the one or more accuracy scores 407, the graphical distribution pattern 408, the comparison 410, the predefined graphical distribution pattern 412, and/or the quality score 414 may be related to a quality assurance pipeline 401 for the training dataset 404 and/or the machine learning model 402.

In various embodiments, based on the quality score 414, the machine learning computing entity 106 (e.g., the action engine 114) initiates one or more prediction-based actions. In certain embodiments, one or more machine learning actions are initiated using the machine learning model 402 based on the quality score 414. For example, the machine learning model 402 may be retrained based on a determination that the quality score 414 is below a certain quality threshold value. The machine learning model 402 may be retrained based on an alternate version of the training dataset 404 that comprises at least one different binary label as compared to the binary labels included in the training dataset 404. In another example, the machine learning model 402 may be utilized for one or more classification tasks based on a determination that the quality score 414 is equal to or above a certain quality threshold value. In certain embodiments, the machine learning model 402 may be utilized to generate prediction output 416 based on a determination that the quality score 414 is equal to or above a certain quality threshold value. The prediction output 416 may be, for example, a classification, diagnostic prediction, insight, and/or inference related to a patient (e.g., related to certain types of disease such as a particular type of rare disease).

Additionally, or alternatively, in certain embodiments, one or more graphical elements for an electronic interface are generated based on the quality score 414. The one or more graphical elements may be included in one or more electronic communications to provide one or more notification via the electronic interface. Additionally, or alternatively, one or more graphical elements may facilitate supervised learning and/or binary labeling with respect to a user to provide the alternate version of the training dataset 404 that comprises at least one different binary label as compared to the binary labels included in the training dataset 404.

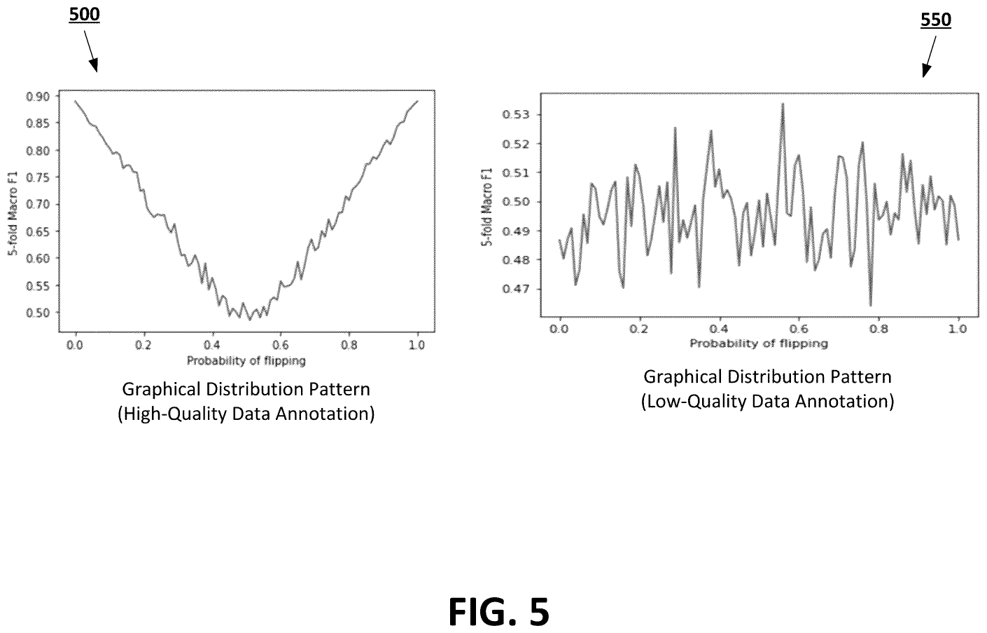

FIG. 5 provides example graphical distribution patterns related to data annotation quality assurance via the comparison 410, in accordance with one or more embodiments of the present disclosure. For example, FIG. 5 illustrates a graphical distribution pattern 500 associated with high-quality data annotation and a graphical distribution pattern 550 associated with low-quality data annotation. The graphical distribution pattern 500 may be an example comparison 410 between the graphical distribution pattern 408 and the predefined graphical distribution pattern 412 where the training dataset 404 is associated with accurate data labeling. As shown, the graphical distribution pattern 500 resembles a parabola and a Hausdorff distance between the graphical distribution pattern 408 and the predefined graphical distribution pattern 412 is 0.23. Additionally, the graphical distribution pattern 550 may be another example comparison 410 between the graphical distribution pattern 408 and the predefined graphical distribution pattern 412 where the training dataset 404 is associated with inaccurate data labeling. As shown, the graphical distribution pattern 550 does not resemble a parabola and a Hausdorff distance between the graphical distribution pattern 408 and the predefined graphical distribution pattern 412 is 0.5. Rather than a parabola, the graphical distribution pattern 550 resembles a random distribution. Accordingly, it may be determined based on a shape pattern analysis of the data that the annotated data related to the graphical distribution pattern 500 is high-quality annotated data and the annotated data related to the graphical distribution pattern 550 is low-quality (e.g., inconsistently) annotated data.

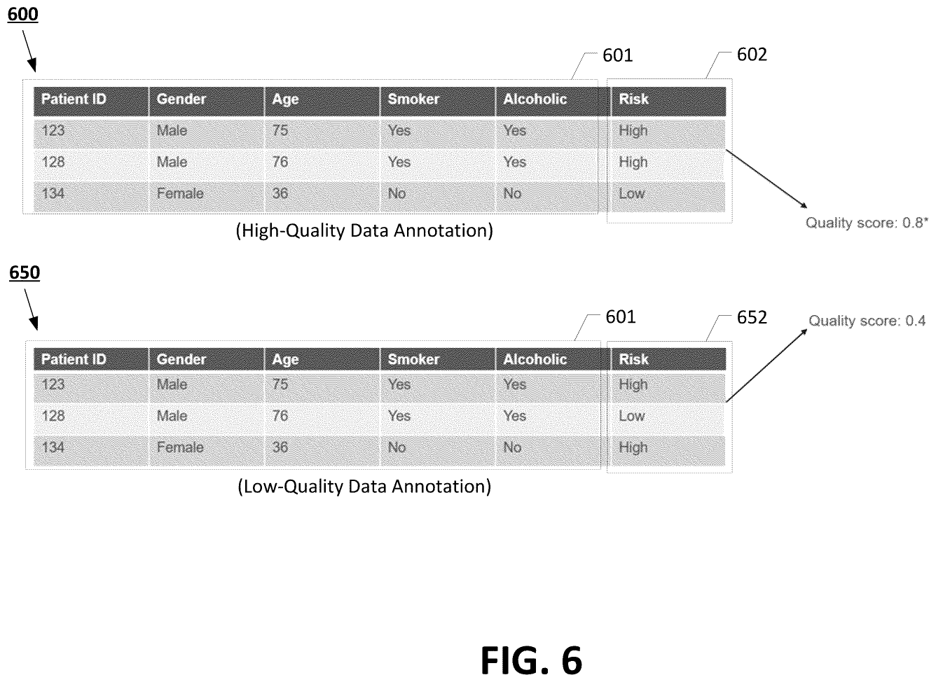

FIG. 6 provides example data associated with high-quality data annotation in accordance with one or more embodiments of the present disclosure. For example, FIG. 6 includes data 600 associated with high-quality data annotation and data 650 associated with low-quality data annotation. The data 600 and the data 650 may include corresponding data features 601 related to patient features such as patient identifiers, genders, age, smoking status, alcoholic status, etc. However, the data 600 and the data 650 may be associated with different classifications. For example, the data 600 may include a first set of labels 602 that includes risk classification labels for patients. Additionally, the data 650 may include a second set of labels 652 that includes one or more different risk classification labels for the patients. The data 600 and the data 605 may also be associated with different quality scores (e.g., quality score 414) as provided by the machine learning computing entity 106 (e.g., the quality assurance engine 112). For example, the data 600 may be associated with a quality score equal to 0.8 that corresponds to high-quality data labeling. However, the data 650 may be associated with a quality score equal to 0.4 that corresponds to low-quality data labeling.

Although the techniques described herein for quality assurance related to machine learning are explained with reference to performing classification data analysis, a person of ordinary skill in the relevant technology will recognize that the disclosed techniques have applications far beyond performing classification data analysis. As an illustrative example, the disclosed techniques may be used in various data visualization applications. As another illustrative example, the disclosed techniques may be used to encode data in data structures that facilitate at least one of data retrieval and data security. In some embodiments, the disclosed techniques may be used to generate video representations or other representations of categorical data (e.g., video representations that illustrate changes in the corresponding categorical data over time).

Machine Learning Actions and/or Visualizations

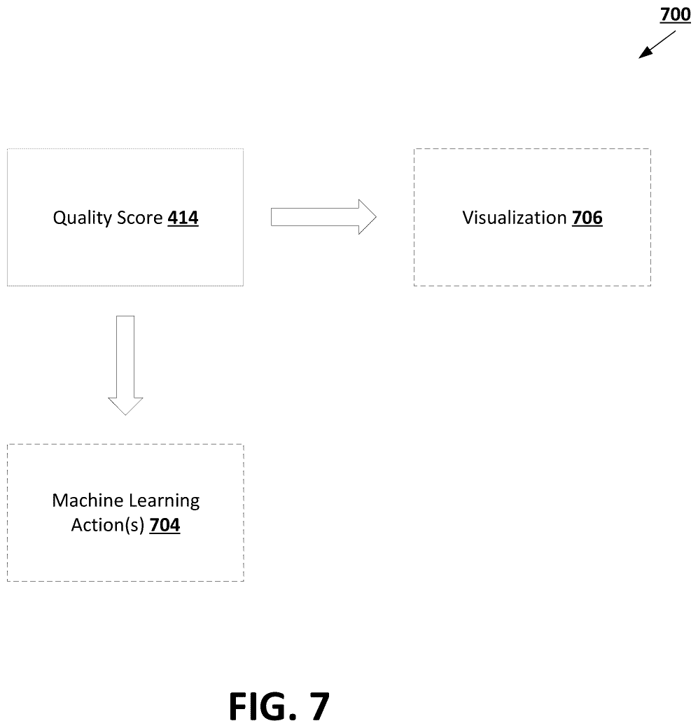

FIG. 7 provides an example computing system 700 that provides for machine learning actions and/or visualizations in accordance with one or more embodiments of the present disclosure. The computing system 700 includes the quality score 414 provided by the machine learning computing entity 106. In one or more embodiments, one or more machine learning actions 704 are performed based on the quality score 414. For example, data associated with the quality score 414 may be stored in a storage system, such as the storage subsystem 108 or another storage system associated with the machine learning system 101. The data stored in the storage system may be employed for reporting, decision-making purposes, operations management, healthcare management, and/or other purposes. In certain embodiments, the data stored in the storage system may be employed to provide one or more insights to assist with healthcare decision making processes, such as, clinical decisions during a clinical review of medical records or for identifying certain types of medical conditions or diseases such as particular type of rare disease. Additionally, or alternatively, the machine learning model 402 may be retrained based on the quality score 414. For example, one or more relationships between features mapped in the machine learning model 402 may be adjusted (e.g., refitted) based on data associated with the quality score 414. In another example, cross-validation, hyperparameter optimization, and/or regularization associated with the machine learning model 402 may be adjusted based on the quality score 414. Additionally, or alternatively, a visualization 706 may be generated based on the quality score 414. The visualization 706 may include, for example, one or more graphical elements for an electronic interface (e.g., an electronic interface of a user device) based on the quality score 414.

It is to be appreciated that the quality score 414 and/or predictions (e.g., classifications) generated based on the quality score 414 may additionally, or alternatively be employed for a number of additional applications. For example, Clinical Decision Support (CDS), Clinical Decisions for Fraud (CDF), automatic claim creation, and/or efficient auditing of payment integrity clinical review decisions may be integrated into the visualization 806. Accordingly, the quality score 414 may be employed to improve efficiency and/or reduce waste in an adjudication process related to medical records. The quality score 414 may also assist clinical reviewers with review of medical records by presenting relevant pages, as calculated by classifications for each claim line. In certain embodiments, the visualization 806 may include visual indicators (e.g., highlights) to indicate insights related to classification decisions (e.g., diagnosis decisions), as provided by the machine learning model 402. Additionally, or alternatively, the quality score 414 and/or predictions (e.g., classifications) generated based on the quality score 414 may be employed to identify potential issues and/or certain content within medical records, thus reducing a number of computing resources. Furthermore, the quality score 414 and/or predictions (e.g., classifications) generated based on the quality score 414 May additionally, or alternatively be employed to identify particular types of decisions by leveraging predicted qualities for different predictive codes with respect to classification decisions. In some embodiments, the visualization 806 may provide a clinical decision support user interface tool related to improve clinical review of medical records.

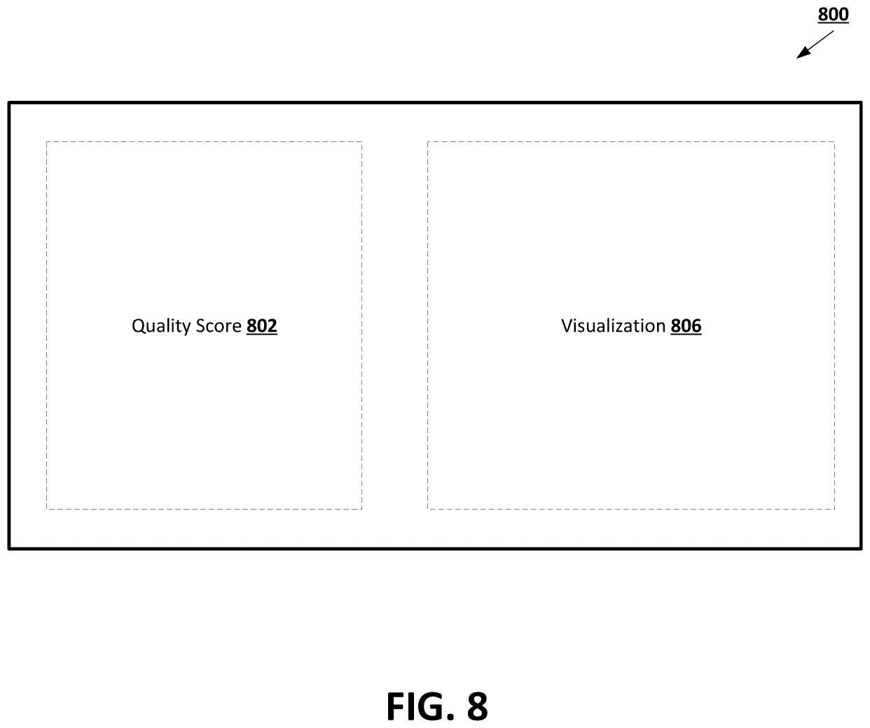

FIG. 8 provides an example user interface 800 related to visualizations in accordance with one or more embodiments of the present disclosure. In one or more embodiments, the user interface 800 is, for example, an electronic interface (e.g., a graphical user interface) of the external computing entity 102. In various embodiments, the user interface 800 may be provided via the display 316 of the external computing entity 102. The user interface 800 may be configured to render the visualization 706. In various embodiments, the visualization 706 may provide a visualization of a prediction output (e.g., one or more classification predictions such as one or more diagnosis predictions) for medical records and/or categorical data related to a patient. For example, the visualization 706 may render one or more visual elements related to a prediction output from the machine learning model 402 (e.g., one or more classification predictions such as one or more diagnosis predictions) for medical records and/or categorical data related to a patient. Additionally, in certain embodiments, the user interface 800 may be configured to render the quality score 802, medical data, and/or other data related to the visualization 706. The quality score 802 may include quality assurance information and/or information to facilitate supervised learning with respect to the machine learning model 402. The medical record data may provide textual information and/or visual information related to medical records and/or categorical data related to a patient. In various embodiments, the user interface 800 may be configured as a user interface (e.g., a clinical decision support user interface, a disease diagnosis support user interface, etc.) for clinical decision automation related to medical records and/or categorical data related to a patient.

Another operational example of prediction-based actions that may be performed based on prediction outputs comprise performing operational load balancing for post-prediction systems that perform post-prediction operations (e.g., automated specialist appointment scheduling operations) based on prediction outputs. For example, in some embodiments, a predictive recommendation computing entity determines D classifications for D prediction input data objects based on whether the selected region subset for each prediction input data object as generated by the predictive recommendation model comprises a target region (e.g., a target brain region). Then, the count of D prediction input data objects that are associated with an affirmative classification, along with a resource utilization ratio for each prediction input data object, may be used to predict a predicted number of computing entities needed to perform post-prediction processing operations with respect to the D prediction input data objects. For example, in some embodiments, the number of computing entities needed to perform post-prediction processing operations (e.g., automated specialist scheduling operations) with respect to D prediction input data objects may be determined based on the output of the equation: R=ceil(Σₖ^{k=K} urₖ), where R is the predicted number of computing entities needed to perform post-prediction processing operations with respect to the D prediction input data objects, ceil(.) is a ceiling function that returns the closest integer that is greater than or equal to the value provided as the input parameter of the ceiling function, k is an index variable that iterates over K prediction input data objects among the D prediction input data objects that are associated with affirmative classifications, and urₖ is the estimated resource utilization ratio for a kth prediction input data object that may be determined based on a patient history complexity of a patient associated with the prediction input data object. In some embodiments, once R is generated, a predictive recommendation computing entity may use R to perform operational load balancing for a server system that is configured to perform post-prediction processing operations with respect to D prediction input data objects. This may be done by allocating computing entities to the post-prediction processing operations if the number of currently-allocated computing entities is below R, and deallocating currently-allocated computing entities if the number of currently-allocated computing entities is above R.

### Generating Prediction Output for Data Using Machine Learning and Quality Assurance

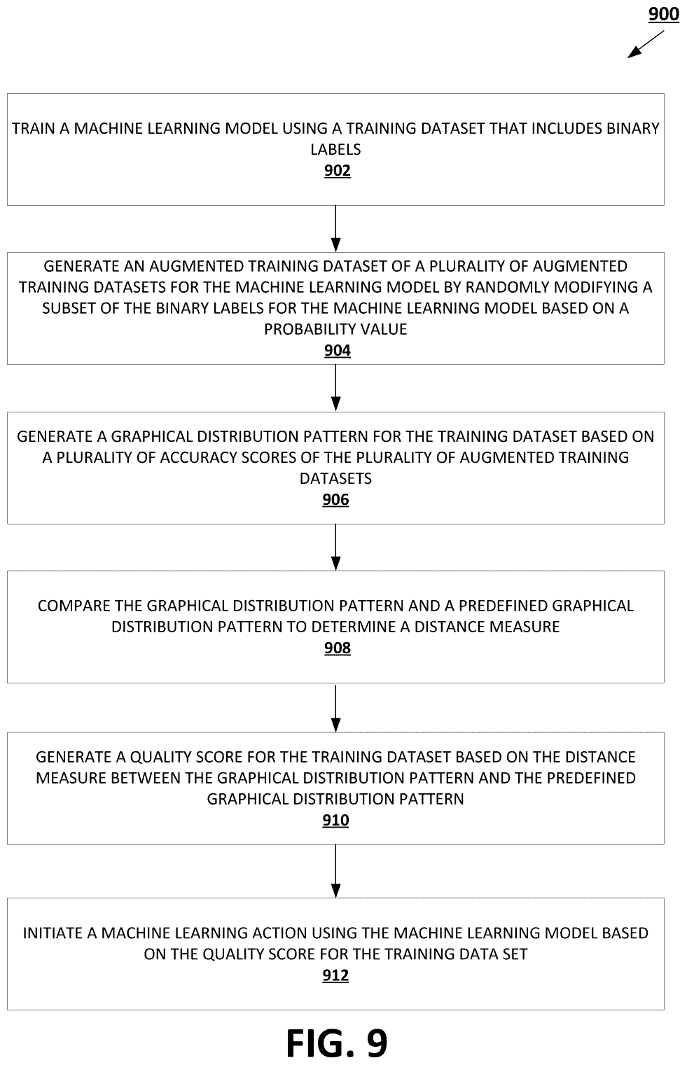

FIG. 9 is a flowchart diagram of an example process 900 for generating a prediction output for data using machine learning and quality assurance in accordance with one or more embodiments of the present disclosure. Via the various steps/operations of process 900, the machine learning computing entity 106 may process the training data 121, the graphical distribution pattern data 122, and/or other data using one or more artificial intelligence techniques (e.g., one or more machine learning techniques) and/or one or more statistical techniques to provide improved prediction output. In doing so, the machine learning computing entity 106 may utilize machine learning solutions to infer important predictive insights, classifications, and/or inferences related to data.

The process 900 begins at step/operation 902 when the training engine 110 of the machine learning computing entity 106 trains a machine learning model using a training dataset that includes binary labels. The machine learning model may be a classification model or another type of machine learning model configured to provide classification predictions for data. The binary labels may be binary labels for text data, numerical data, and/or categorical data.

At step/operation 904, the quality assurance engine 112 of the machine learning computing entity 106 generates an augmented training dataset of a plurality of augmented training datasets for the machine learning model by randomly modifying a subset of the binary labels for the machine learning model based on a probability value.

At step/operation 906, the quality assurance engine 112 of the machine learning computing entity 106 generates a graphical distribution pattern for the training dataset based on a plurality of accuracy scores of the plurality of augmented training datasets.

At step/operation 908, the quality assurance engine 112 of the machine learning computing entity 106 compares the graphical distribution pattern and a predefined graphical distribution pattern to determine a distance measure.

At step/operation 910, the quality assurance engine 112 of the machine learning computing entity 106 generates a quality score for the training dataset based on the distance measure between the graphical distribution pattern and the predefined graphical distribution pattern.

At step/operation 912, the action engine 114 of the machine learning computing entity 106 initiates a machine learning action using the machine learning model based on the quality score for the training dataset. In certain embodiments, one or more classifications are provided by the machine learning model based on the quality score. In certain embodiments, the machine learning model is retrained based on the quality score. In certain embodiments, one or more graphical elements for an electronic interface are additionally, or alternatively generated based on the quality score.

In various embodiments, the step/operation 902, the step/operation 904, the step/operation 906, the step/operation 908, the step/operation 910, and/or the step/operation 912 may be repeated for each training dataset and/or machine learning model undergoing quality assurance.

Accordingly, as described above, various embodiments of the present disclosure address technical challenges related to accurately, efficiently, and/or reliably performing machine learning data analysis of data stored in disparate data sources. For example, in various embodiments, proposed solutions provide quality assurance for modeling using machine learning. In various embodiments, proposed solutions disclose classification predictions using machine learning. After the one or more machine learning models are generated, trained, and/or analyzed via the quality assurance disclosed herein, the one or more machine learning models may be utilized to perform accurate, efficient, and reliable classification predictions. Accordingly, techniques that improve predictive accuracy without harming training speed, such as various techniques described herein, enable improving training speed given a constant predictive accuracy. Therefore, by improving accuracy of performing machine learning predictions, various embodiments of the present disclosure improve the training speed of machine learning frameworks.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method, the computer-implemented method comprising: generating, by one or more processors, an augmented training dataset of a plurality of augmented training datasets for a machine learning model by randomly modifying a subset of binary labels of a training dataset for the machine learning model based on a probability value; generating, by the one or more processors, a graphical distribution pattern for the training dataset based on a plurality of accuracy scores of the plurality of augmented training datasets; generating, by the one or more processors, a quality score for the training dataset based on a comparison between the graphical distribution pattern and a predefined graphical distribution pattern; and initiating, by the one or more processors, a machine learning action using the machine learning model based on the quality score for the training dataset.

Example 2. The computer-implemented method of any of the preceding examples, wherein the machine learning action comprises using the machine learning model to generate a classification output responsive to the quality score achieving a quality criterion.

Example 3. The computer-implemented method of any of the preceding examples, wherein the machine learning action comprises one or more model retraining operations responsive to the quality score failing to achieve a quality criterion.

Example 4. The computer-implemented method of any of the preceding examples, further comprising, in response to a determination that the quality score does not satisfy quality criterion, retraining the machine learning model based on an alternate version of the training dataset that comprises at least one different binary label as compared to the subset of binary labels.

Example 5. The computer-implemented method of any of the preceding examples, further comprising, in response to a determination that the quality score does not satisfy quality criterion, causing transmission of an electronic communication that comprises a request to update the training dataset.

Example 6. The computer-implemented method of any of the preceding examples, wherein the comparison between the graphical distribution pattern and the predefined graphical distribution pattern is based on a shape pattern analysis between the graphical distribution pattern and the predefined graphical distribution pattern.

Example 7. The computer-implemented method of any of the preceding examples, wherein the comparison between the graphical distribution pattern and the predefined graphical distribution pattern is based on a Hausdorff distance between the graphical distribution pattern and the predefined graphical distribution pattern.

Example 8. The computer-implemented method of any of the preceding examples, wherein the predefined graphical distribution pattern is based on a predefined parabola pattern representative of an annotation quality assurance profile for a binary labeled training dataset.

Example 9. The computer-implemented method of any of the preceding examples, wherein the respective accuracy scores correspond to respective F-scores indicative of a machine learning metric for classification accuracy associated with the machine learning model.

Example 10. The computer-implemented method of any of the preceding examples, wherein the probability value indicates a size of the subset of binary labels.

Example 11. The computer-implemented method of any of the preceding examples, wherein generating the graphical distribution pattern comprises mapping the respective accuracy scores for the plurality of augmented training datasets against the respective probability value.

Example 12. The computer-implemented method of any of the preceding examples, wherein the augmented training dataset comprises one or more different binary labels as compared to the binary labels of the training dataset.

Example 13. A computing apparatus comprising memory and one or more processors communicatively coupled to the memory, the one or more processors configured to generate an augmented training dataset of a plurality of augmented training datasets for a machine learning model by randomly modifying a subset of binary labels of a training dataset for the machine learning model based on a probability value; generate a graphical distribution pattern for the training dataset based on a plurality of accuracy scores of the plurality of augmented training datasets; generate a quality score for the training dataset based on a comparison between the graphical distribution pattern and a predefined graphical distribution pattern; and initiate a machine learning action using the machine learning model based on the quality score for the training dataset.

Example 14. The computing apparatus of any of the preceding examples, wherein the one or more processors are further configured to: utilize the machine learning model to generate a classification output responsive to the quality score achieving a quality criterion.

Example 15. The computing apparatus of any of the preceding examples, wherein the comparison between the graphical distribution pattern and the predefined graphical distribution pattern is based on a shape pattern analysis between the graphical distribution pattern and the predefined graphical distribution pattern.

Example 16. The computing apparatus of any of the preceding examples, wherein the comparison between the graphical distribution pattern and the predefined graphical distribution pattern is based on a Hausdorff distance between the graphical distribution pattern and the predefined graphical distribution pattern.

Example 17. The computing apparatus of any of the preceding examples, wherein the predefined graphical distribution pattern is based on a predefined parabola pattern representative of an annotation quality assurance profile for a binary labeled training dataset.

Example 18. The computing apparatus of any of the preceding examples, wherein the respective accuracy scores correspond to respective F-scores indicative of a machine learning metric for classification accuracy associated with the machine learning model.

Example 19. The computing apparatus of any of the preceding examples, wherein the probability value indicates a size of the subset of binary labels.

Example 20. One or more non-transitory computer-readable storage media including instructions that, when executed by one or more processors, cause the one or more processors to: generate an augmented training dataset of a plurality of augmented training datasets for a machine learning model by randomly modifying a subset of binary labels of a training dataset for the machine learning model based on a probability value; generate a graphical distribution pattern for the training dataset based on a plurality of accuracy scores of the plurality of augmented training datasets; generate a quality score for the training dataset based on a comparison between the graphical distribution pattern and a predefined graphical distribution pattern; and initiate a machine learning action using the machine learning model based on the quality score for the training dataset.

1. A computer-implemented method, the computer-implemented method comprising:
generating, by one or more processors, an augmented training dataset of a plurality of augmented training datasets for a machine learning model by randomly modifying a subset of binary labels of a training dataset for the machine learning model based on a probability value;
generating, by the one or more processors, a graphical distribution pattern for the training dataset based on a plurality of accuracy scores of the plurality of augmented training datasets;
generating, by the one or more processors, a quality score for the training dataset based on a comparison between the graphical distribution pattern and a predefined graphical distribution pattern; and
initiating, by the one or more processors, a machine learning action using the machine learning model based on the quality score for the training dataset.

2. The computer-implemented method of claim 1, wherein the machine learning action comprises using the machine learning model to generate a classification output responsive to the quality score achieving a quality criterion.

3. The computer-implemented method of claim 1, wherein the machine learning action comprises one or more model retraining operations responsive to the quality score failing to achieve a quality criterion.

4. The computer-implemented method of claim 1, further comprising:
in response to a determination that the quality score does not satisfy quality criterion, retraining the machine learning model based on an alternate version of the training dataset that comprises at least one different binary label as compared to the subset of binary labels.

5. The computer-implemented method of claim 1, further comprising:
in response to a determination that the quality score does not satisfy quality criterion, causing transmission of an electronic communication that comprises a request to update the training dataset.

6. The computer-implemented method of claim 1, wherein the comparison between the graphical distribution pattern and the predefined graphical distribution pattern is based on a shape pattern analysis between the graphical distribution pattern and the predefined graphical distribution pattern.

7. The computer-implemented method of claim 1, wherein the comparison between the graphical distribution pattern and the predefined graphical distribution pattern is based on a Hausdorff distance between the graphical distribution pattern and the predefined graphical distribution pattern.

8. The computer-implemented method of claim 1, wherein the predefined graphical distribution pattern is based on a predefined parabola pattern representative of an annotation quality assurance profile for a binary labeled training dataset.

9. The computer-implemented method of claim 1, wherein the respective accuracy scores correspond to respective F-scores indicative of a machine learning metric for classification accuracy associated with the machine learning model.

10. The computer-implemented method of claim 1, wherein the probability value indicates a size of the subset of binary labels.

11. The computer-implemented method of claim 10, wherein generating the graphical distribution pattern comprises mapping the respective accuracy scores for the plurality of augmented training datasets against the probability value.

12. The computer-implemented method of claim 1, wherein the augmented training dataset comprises one or more different binary labels as compared to the binary labels of the training dataset.

13. A computing system comprising memory and one or more processors communicatively coupled to the memory, the one or more processors configured to:
generate an augmented training dataset of a plurality of augmented training datasets for a machine learning model by randomly modifying a subset of binary labels of a training dataset for the machine learning model based on a probability value;
generate a graphical distribution pattern for the training dataset based on a plurality of accuracy scores of the plurality of augmented training datasets;
generate a quality score for the training dataset based on a comparison between the graphical distribution pattern and a predefined graphical distribution pattern; and
initiate a machine learning action using the machine learning model based on the quality score for the training dataset.

14. The computing system of claim 13, wherein the one or more processors are further configured to:
utilize the machine learning model to generate a classification output responsive to the quality score achieving a quality criterion.

15. The computing system of claim 13, wherein the comparison between the graphical distribution pattern and the predefined graphical distribution pattern is based on a shape pattern analysis between the graphical distribution pattern and the predefined graphical distribution pattern.

16. The computing system of claim 13, wherein the comparison between the graphical distribution pattern and the predefined graphical distribution pattern is based on a Hausdorff distance between the graphical distribution pattern and the predefined graphical distribution pattern.

17. The computing system of claim 13, wherein the predefined graphical distribution pattern is based on a predefined parabola pattern representative of an annotation quality assurance profile for a binary labeled training dataset.

18. The computing system of claim 13, wherein the respective accuracy scores correspond to respective F-scores indicative of a machine learning metric for classification accuracy associated with the machine learning model.

19. The computing system of claim 13, wherein the probability value indicates a size of the subset of binary labels.

20. One or more non-transitory computer-readable storage media including instructions that, when executed by one or more processors, cause the one or more processors to:
generate an augmented training dataset of a plurality of augmented training datasets for a machine learning model by randomly modifying a subset of binary labels of a training dataset for the machine learning model based on a probability value;
generate a graphical distribution pattern for the training dataset based on a plurality of accuracy scores of the plurality of augmented training datasets;
generate a quality score for the training dataset based on a comparison between the graphical distribution pattern and a predefined graphical distribution pattern; and
initiate a machine learning action using the machine learning model based on the quality score for the training dataset.
